(19) United States
(12) Patent Application Publication
(10) Pub. No.: US 2010/0203361 A1
(43) Pub. Date: Aug. 12, 2010

(54) BIOLOGICAL FUEL CELL

(75) Inventors: Giuliano Claudio Premier, Pontypridd (GB); Jung Rae Kim, Pontypridd (GB)

Correspondence Address: MERCHANT & GOULD PC, P.O. BOX 2903, MINNEAPOLIS, MN, 55402-0903, US

(73) Assignee: UGCS (University of Glamorgan Commercial Services) Ltd., Pontypridd (GB)

(21) Appl. No.: 12/665,919

(22) PCT Filed: Jul. 2, 2008
(86) PCT No.: PCT/GB2008/002285

§ 371 Date: Apr. 21, 2010

(30) Foreign Application Priority Data
Jul. 3, 2007 (GB) 0712868.9

(51) Int. Cl. H01M 8/16

(52) U.S. Cl. 429/2

(57) ABSTRACT

A biological fuel cell includes an elongate anode (1) and a flow conduit (2) though which a fluid having a substrate flows. The ratio of the length of the flow conduit (2) to the width of the flow conduit is at least 4:1. In use, the biological fuel cell is arranged so that fluid flows within the flow conduit (2) along the length of the elongate anode (1) and the fluid flows substantially parallel to the anode (1) for at least 80% of its length.

The invention relates to biological fuel cells especially microbial fuel cells (MFCs).

### BACKGROUND TO THE INVENTION

In a fuel cell an electrochemical reaction involving a substrate occurs in the presence of a catalyst. In a conventional fuel cell the catalyst is generally an inorganic catalyst whilst in a biological fuel cell the catalyst is a biological catalyst such as an enzyme or, in the case of a microbial fuel cell (MFC), a bacterium or microbe. The substrate, sometimes referred to as the fuel of the fuel cell, is a reactant that is consumed in the electrochemical reaction. In a biological fuel cell the substrate typically includes complex organic compounds such as volatile fatty acids, starches and sugars that are digested by the enzymes or bacteria of the cell. Substrate is introduced into a chamber in which the anode is situated (the “anode chamber”) and reacts in an electrochemical reaction catalysed by the catalyst to produce electrons and positively charged ions. In order for an electrical circuit to be completed, electrical charge must be transferred between the electrochemical reaction site and the electrodes. The electrons produced in an electrochemical reaction in a fuel cell flow from the anode through an external circuit (load) to the cathode. The positive ions (cations) travel through the electrolyte to the cathode. At the cathode electrons are combined with cations in a further electrochemical reaction. In some instances an ion-exchange membrane is present that separates the fluid-containing chamber of a fuel cell into an anode chamber and a separate cathode chamber. The positive charge is transferred from the anode chamber across the ion-exchange membrane to form a neutral species in the cathode chamber.

In a standard MFC, substrate is metabolized by the bacteria harvesting their life energy through electron transport chain which can be subverted to partake in the electrochemical reaction or transfer electrons directly to the anode. Bacteria in an anode chamber catalyse the oxidation of a substrate during bacterial cell respiration. The electrons produced from that bacterial respiration are released to the anode, either directly or via a mediator. Positively charged ions such as protons are also released into a fluid electrolyte present in the anode chamber.

The term “fuel cell” used herein encompasses both conventional systems that are used to generate electricity and other systems in which substrate is consumed in an electrochemical process involving an electrical circuit. Thus, the term “fuel cell” may include waste and effluent treatment systems and the like in which the primary purpose is to consume waste matter rather than to generate electricity. In some embodiments of the invention electrical energy may be supplied to the system in order to drive the electrochemical processes of a cell. The fuel cell may operate as a reverse fuel cell in which electrical energy is supplied to the system to promote the metabolism of organic matter and/or accelerate the production of a useful product. A reverse fuel cell may also be operated as a bio-electrochemically assisted microbial reactor (BEAMR) that produces hydrogen. Thus the term “fuel cell” is to be understood to encompass such systems.

Developments in fuel cell design have been driven by the need to maximize current density with respect to anode area or volume. However, biological fuel cells and microbial fuel cells (MFCs) in particular are limited in several senses in their current state of development. A critical issue is the spatial arrangement of the anode and cathode, regardless of the presence or absence of an ion-exchange membrane. A compromise exists between various over-potentials related to ohmic, activation and mass transfer losses and volume available for bacteria or other catalyst and the substrate. In general, the larger the volume of the cell the less efficient it will be in transferring charge from the electrochemical reaction site to an electrode. Increased separation between the catalyst and electrode or turbulent fluid flow patterns will induce ohmic losses. Ohmic losses in the reactor are also dependent on the scale of the reactor, the distance to the electrode and the surface area of the electrode compared to the fluid volume. Mass transfer and activation losses arise from substrate inhibition of catalytic sites or concentration gradients limiting access of the catalyst to the substrate and are affected by local environments about the catalyst site. In order for a fuel cell to operate efficiently, reactants must be supplied to an electrochemical site and products removed. Accordingly, it is common for the fluid in the anode chamber to be constantly mixed or agitated, for example by a stirrer, by a fluid flow pattern or by gas sparging, such as pumping N₂ through an anaerobic anode chamber, thus enabling substrate to be continually supplied to a reaction site and reaction products to be removed.

Waste water, industrial effluent, agricultural effluent and the like is typically a dilute aqueous solution with relatively low concentrations or organic matter suspended or dissolved in a large volume of water. Accordingly, it is desirable for biological reactors to handle large volumes of liquids enabling large quantities of substrate-containing fluid to be processed by the reactor. On way of achieving this is to operate the reactor as a continuously fed reactor in which substrate-containing fluid continually passes through the reactor. It is preferable in a biological reactor for biomass comprising a biological catalyst to be retained in the reactor. Retention of biomass may be accomplished by settling or membrane separation of bacteria or by facilitating the agglomeration of bacteria into biofilms, flocks or granules which are more easily retained in the reactor. Fluidised bed systems use a carrier medium which becomes colonised by bacteria which form a biofilm on the surface of the carrier medium. A difficulty with using a similar reactor arrangement to contain the anode chamber of a conventional biological fuel cell is that high (so called) overpotential losses would be incurred due to the resistance of the fluid and the distance to a localized anode.

An MFC described by Liu, Ramnaraynan and Logan in Environ. Sci. Technol. 2004, 38, 2281-2285 has a single 15 cm long cylindrical glass chamber of 6.5 cm in diameter with eight 15 cm long graphite rod anodes in a concentric arrangement within it. Waste water is pumped through the tube and the organic matter within the water is consumed by bacteria to generate some electricity. The authors state that although the goal of treating waste water is achieved by such a cell, the fraction of organic matter converted to electricity is low.

An anode that is distributed through the chamber as a plurality of plates, dendritic attachments, a matrix or as a mesh or the like may, to some extent, alleviate the losses due to distance to the anode but the distributed anode may impede the mass transfer which is needed to supply substrate to the biological catalyst and to remove inhibitory products from the vicinity of the biological catalyst. An example of a distributed anode in a continuously fed MFC is that described by Rabaey et al in “Tubular Microbial Fuel Cells for Efficient Electricity Generation”, Environ. Sci. Technol., 2005, 39, 8077-8082 where the anode chamber includes graphite granules that are immobilised as an anode matrix and function as an anode that is distributed in the anode chamber. A packed bed of graphite granules that are distributed throughout the flow conduit interrupts the flow of the fluid past the anode. Anodes based on packed beds of graphite granules can also result in reduced conductivity due to inefficient transfer of electrons at material grain structure interfaces.

### SUMMARY OF THE INVENTION

The invention provides an apparatus for use in a biological fuel cell comprising an elongate anode, a cathode and a flow conduit though which a fluid comprising a substrate flows, wherein the flow conduit is arranged so that, in use, the fluid comprising the substrate flows along the elongate anode and flows substantially parallel to at least 80% of the length of the elongate anode; and the ratio of the length of said flow conduit to the width of said flow conduit is at least 4:1. The invention further provides a biological fuel cell comprising the apparatus described above. In operation, the biological fuel cell also comprises a biological catalyst and a fluid comprising a substrate. The invention further provides a method of operating a biological fuel cell comprising an elongate anode, a cathode and a flow conduit through which a fluid comprising a substrate flows, wherein the aspect ratio of the length of said flow conduit to the width of said flow conduit is at least 4:1, the method including the steps of causing the fluid to flow within the flow conduit along the length of the elongate anode; and causing the fluid to flow substantially parallel to the anode for at least 80% of the length of the anode.

The apparatus of the invention has been found to provide an advantageous spatial distribution of the system elements of a biological fuel cell. The high aspect ratio of the length of said flow conduit to the width of said flow conduit containment vessel of at least 4:1 allows the distance between the anode and the cathode to be relatively small compared to the length of the elongate anode and the volume of the flow conduit. Thus, ohmic losses, which are proportional to the distance between the electrodes, have been found to be at an acceptable level in the fuel cell of the invention and generally reduced as compared to conventional designs of equivalent anode chamber liquid volume.

The power output of a fuel cell is proportional to the volume of fluid that comes into contact with the anode and the anode surface area. The arrangement of the apparatus and fuel cell of the invention has been found to provide good access of fluid to the anode due to a relatively large anode surface area compared to the cross sectional area of the flow conduit resulting in acceptable activation losses and thus an acceptable power output. Thus, it has been found that the fuel cells of the invention that provide a large flow conduit volume and anode area whilst maintaining a relatively small anode-cathode separation can operate efficiently.

Preferably the fuel cell is continuously fed and operates with a continuous flow of fluid passing though the flow conduit. The continuous flow of fluid through the cell of the invention has been found to reduce concentration overpotential losses by providing a continuous supply of substrate (reactants) to the electrochemical reaction site at the anode and continuous removal of reaction products.

Advantageously the ratio of the length of said flow conduit to the width of said flow conduit is at least 5:1, preferably at least 8:1, more preferably at least 15:1 and especially at least 20:1. In some particularly advantageous embodiments the aspect ratio of the length of said flow conduit to the maximum width of said flow conduit is at least 50:1 and more preferably at least 100:1. Preferably, the ratio of the length of said flow conduit to the width of said flow conduit is no more than 100,000:1 and more preferably the length of said flow conduit to the width of said flow conduit is no more than 1000:1. For the avoidance of doubt, the flow conduit is the conduit through which fluid flows as it passes along the elongate anode. A fuel cell may comprise other conduits, pipes and the like along which fluid may flow other than along the elongate anode and those other conduits, pipes and the like are not part of the flow conduit of the invention. Accordingly, the length of the flow conduit is the length of the conduit along which fluid flows as it passes along the elongate anode. The width of the flow conduit is the separation between the walls of the flow conduit. For example, in embodiments in which the flow conduit has a circular cross section, the width of the flow conduit is the diameter. Advantageously, the separation of the anode and the cathode is less than 50% of the width of the flow conduit, preferably the separation is no more than 40%, more preferably the separation is no more than 20% and especially the separation is no more than 10% of the width of the flow conduit. Preferably, the separation of the anode and the cathode is at least 0.01% of the width of the flow conduit. Advantageously, the separation of the anode and the cathode is no more than 10% of the length of the elongate anode, preferably the separation is no more than 6%, more preferably the separation is no more than 4% and especially the separation is no more than 2% of the length of the elongate anode. Preferably, the separation of the anode and the cathode is at least 0.001% of the length of the elongate anode. Preferably, the separation of the anode and the cathode is less than 500 mm, more preferably the separation of the anode and the cathode is no more than 100 mm. Preferably, the separation of the anode and the cathode is at least 0.001 mm. It has been found that by increasing the length of the flow conduit whilst maintaining the same cross sectional configuration of the cell and in particular maintaining the same separation between the elongate anode and the cathode, the power output of the fuel cell can be increased. Thus, the invention may enable large biological fuel cell reactors to be produced providing high power outputs, such reactors having large flow conduit volumes, for example, of the order of 10 litres of more, with a small distance between the anode and the cathode, for example, of the order of 10 cm or less. The invention may also enable biological fuel cells to be miniaturized with relatively high power outputs being possible from very small cells. The fuel cell arrangement of the invention and the method of operating a fuel cell of the invention has been found to be particularly suited to microbial fuel cells (MFCs) in which the biological catalyst comprises a microbe or bacteria.

Advantageously, the apparatus is arranged so that the flow of fluid past the elongate anode in a substantially plug flow. Plug flow is a theoretical state in which a fluid flows through a vessel such as a reactor vessel in which no back mixing of fluid in the direction of flow is assumed with perfect mixing in the direction orthogonal to flow. Thus, “plugs” of homogeneous fluid pass through the reactor. Of course, perfect plug flow is not possible to attain with friction preventing perfect plugs of fluid moving down a vessel and with some mixing in the direction of flow being inevitable, for example due to diffusion. The term “substantially plug flow” used herein refers to a state approaching theoretical plug flow in which there is essentially no mixing of fluid in the direction of fluid flow. Advantageously, the apparatus is arranged so that the flow of fluid is mixed in a direction perpendicular to the direction of flow. For example, the apparatus may be designed to generate turbulence in the flow that promotes mixing in a direction perpendicular to the direction of flow. Mixing in a direction perpendicular to the direction of flow may be promoted by virtue of a relatively small cross-section available for flow in the biological fuel cells of the invention. In particular, it has been found that a small cross-section may lead to relatively high flow velocities which promote mixing in a direction perpendicular to the direction of flow.

The degree of mixing in a direction parallel to the direction of flow of a fluid flowing through a flow conduit can be measured using a tracer experiment in which a detectable tracer is submitted to the flow through a tracer inlet (which may be at the fluid inlet to the flow conduit) in a timed pulse. The tracer need only be clearly detectable by chemical analysis, the quantity of tracer required being dependant on the tracer compound and the detection methodology. An example tracer is a solution of lithium chloride, that is detectable by ion chromatography or flame photometry. Lithium chloride is relatively inert and also not naturally present in typical biological fuel cell systems at significant concentrations. In one embodiment, 100 mg of lithium chloride is used as tracer. It is preferable to use small quantities of tracer compound to minimize concentration diffusion effects whilst maintaining a measurable concentration of tracer. The concentration of the tracer can be monitored over time at a position downstream of a tracer inlet (for example the outlet of the flow conduit) and it is possible to detect the concentration suddenly rising, then reducing to low concentrations as the pulse of tracer passes at the downstream monitoring position. Such experiments can be used to determine a measure for plug flow.

In a theoretical system operating with perfect plug flow, the time taken for the tracer to pass the downstream monitoring position would equal the time taken for the tracer to be introduced at the inlet. In a real system, some mixing of fluid in the direction of flow is inevitable, due to axial dispersion and boundary layer effects, and disturbances at the inlet and outlet of the flow conduit. Accordingly, the difference in time between the time taken to introduce the volume of tracer fluid at the inlet (T₁) and the time taken for 70% of the tracer to pass the downstream monitoring position (T₂) is determined as a measure of plug flow. As the degree of mixing in a real system will be dependent on distance (D) between the inlet and the downstream monitoring position (or outlet) and the flow velocity (V) and that should be factored in when assessing how close to plug flow a flow pattern is. The average time taken for fluid to flow between upstream tracer inlet and the downstream monitoring position can be calculated by dividing the distance (D) between the centre of the tracer fluid inlet and the downstream monitoring position by the average flow velocity (V) of the fluid in the flow conduit. If not known, the average flow velocity (V) can be determined by measuring the rate at which fluid leaves the flow conduit. Alternatively, the average time taken for a marker to travel in the flow from the centre of the tracer inlet and the downstream monitoring position could be measured (D/V). A practical measure of how close a flow of fluid through a conduit is to plug flow would be to compare the increase in time for 70% of the introduced tracer to pass the downstream monitoring position (T₂−T₁) with the average time taken for fluid to flow between the position of the upstream tracer inlet and the downstream monitoring position (D/V). The plug flow measure is calculated according to Formula I and is presented as a percentage of plug flow (P) with theoretical perfect plug flow being 100% (as T₂−T₁ is 0 in the case of perfect plug flow).

P=100(1−[V(T₂−T₁)/D]) Formula I

For example, in one embodiment, the biological fuel cell may have a flow conduit with a tracer fluid concentration monitoring position at an outlet that is 2 m downstream of the tracer inlet. The fuel cell may be operated so that fluid flows through the flow conduit with a flow rate of 0.5 m/h (metres per hour). If 100 mg of LiCl tracer is introduced over a 1 minute period (0.01667 hours) and it takes 40 minutes (0.66667 hours) for 70% of the tracer to pass the outlet at that flow rate, the measure will be 100−100*0.5*(0.65)/2=83.75% plug flow.

Substantially plug flow may be defined as at least 10% plug flow calculated according to Formula I. The flow conduit may be arranged so that in operation of the fuel cell fluid flows substantially parallel to the anode for at least 80% of the length of the anode with a flow of at least 1% plug flow, advantageously with a flow of at least 5% plug flow, preferably at least 20% plug flow, more preferably at least 40% and especially at least 60% plug flow calculated according to formula I. In some embodiments the flow conduit is arranged so that in operation of the fuel cell fluid flows substantially parallel to the anode for at least 80% of the length of the anode, with a flow of at least 80% plug flow calculated according to formula I. The method of operating a biological fuel cell of the invention may comprise the step of causing the fluid to flow substantially parallel to the anode for at least 80% of the length of the anode, with a flow of at least 1% plug flow, advantageously with a flow of at least 5% plug flow, preferably at least 20% plug flow, more preferably at least 20% plug flow and especially at least 60% plug flow calculated according to formula I. In some embodiments the method of operating the biological fuel of the invention may comprise the step of causing the fluid to flow substantially parallel to the anode for at least 80% of the length of the anode, with a flow of at least 80% plug flow calculated according to formula I. A flow that is very far from plug flow will have a highly negative plug flow measure calculated according to Formula I, for example, a flow of −200% plug flow.

Preferably, the fuel cell of the invention are arranged to have little or no mixing of the fluid in the direction of flow. The flow conduit may be arranged so flow of fluid past the elongate anode is not interrupted in a manner that causes mixing in the direction of flow. For example, the flow conduit of the apparatus and fuel cell of the invention is preferably free of devices such as baffles or stirrers that are intended to result in mixing of the fluid in the direction of flow. The flow conduit of the apparatus and fuel cell of the invention may comprise devices such as baffles or stirrers that are intended to result in mixing of the fluid in a direction perpendicular to the direction of flow. The apparatus may be arranged so that the flow of fluid past the elongate anode is smooth. Preferably, the fluid flows substantially parallel to the elongate anode along the majority of, and more preferably essentially the entire length of, the elongate anode. Preferably, the fluid flows in a substantially plug flow along the majority of, and more preferably essentially the entire length of, the elongate anode. Preferably, the fluid flows parallel to, and in a substantially plug flow along, the entire length of the elongate anode.

Advantageously, the flow conduit is tubular. A tubular flow conduit has been found to be relatively simple to construct. The flow conduit may be flexible. Preferably the flow conduit is of substantially constant cross section along the length of the elongate anode. A flow conduit of constant cross section has been found to facilitate the operation of a fuel cell with a substantially plug flow and a constant flow velocity. Furthermore, a flow conduit of consistent cross section has been found to be relatively straightforward to manufacture, for example by an extrusion process or by drawing. The flow conduit may have a rounded cross section for example, a curvilinear or circular cross section. Rounded cross sections may assist the smooth flow of fluid through the conduit. The flow conduit may be straight or curved, for example in a coil. The flow conduit may be cylindrical, for example a right cylinder.

The anode is an elongate member which is longer in one dimension than the others and is arranged so that fluid flowing down the flow conduit passes down the longer length of the anode. The elongate anode is preferably a unitary anode. A unitary anode may be a monolithic anode of a single piece of conducting material, for example a carbon rod or a unitary anode consisting of a plurality of components, for example a core coated or covered in a conducting material. The elongate anode may comprise a plurality of conducting granules or the like contained in permeable elongate container, for example, a container comprising a perforated tube or a membrane. The sampling of the biological catalyst, for example for testing or for use in inoculating another fuel cell, is facilitated by the provision of a unitary anode rather than, for example, an anode consisting of a packed bed of conducting granules distributed in the flow conduit. The anode may form at least a part of a wall of the flow conduit. For example, the elongate anode may be a tube through which fluid flows. Embodiments in which the elongate anode forms part of the wall of the flow conduit have been found to facilitate connection of the anode to a load. The elongate anode may be surrounded by the flow conduit. Surrounding the elongated anode by the flow conduit may facilitate access of the fluid to the elongate anode and may enable the anode to present a large surface area to the fluid. Preferably, the anode has a rounded cross section or other smooth shape. Preferably, the anode is of substantially constant cross section for the majority of its length. Preferably, the anode is shaped so not to substantially disrupt fluid flow. Anodes positioned so that they are surrounded by the flow conduit that have a smooth-shaped cross section have been found to facilitate the provision of a smooth plug flow in the fluid conduit. The anode may have end portions that are of a different shape to the majority of its length, for example, the ends of an anode may be profiled so as to cause reduced turbulence in a fluid that flows past the anode so as not to disrupt the substantially plug flow of the fluid. The fuel cell may comprise a plurality of anodes. The fuel cell may contain more than one type of anode. The elongate anode is preferably arranged such that microbes may become attached to the elongate anode, for example the elongate anode may be porous or include a rough surface to facilitate the attachment of microbes. A rough or porous anode surface may be formed by the manufacturing process, by abrading the surface of the anode or by wrapping the anode in a conductive textile, such as a carbon textile, to encourage attachment of biomass. Preferably, the elongate anode is connected to a load at more than one point along its length.

The cathode is advantageously elongate and is arranged lengthwise parallel to the flow conduit. Preferably, the cathode is arranged parallel to the anode. Preferably, the cathode is outside the flow conduit. Preferably, at least a part of a wall of the flow conduit is arranged to allow cations to pass through. In one embodiment the cathode is wrapped round at least half the circumference of the flow conduit. Preferably the cathode extends round at least 20% of the circumference of the flow conduit, more preferably at least 60% of the flow conduit and especially at least 80% of the circumference. It has been found that the greater the proportion of the perimeter of the flow conduit that is adjacent to a cathode the more efficient the charge transfer from the electrochemical site at the anode to the cathode is in use.

In use, the anode and the cathode are separated by a non-electrically conducting, electrically insulating material which can transport ionic species. In operation, the path of lowest electrical resistance from the anode to the cathode is therefore through the load. Advantageously, the cathode is separated from the anode by a non-electrically conducting member. A separator which has ion exchange capability may be present between the cathode and the anode. Preferably, the separator is an ion exchange membrane. In operation of the fuel cell of the invention charge is transferred across the non-electrically conducting member thereby completing an electrical circuit. For example, ions may pass across the member or the member may be an ion exchange membrane across which charge is transferred. The ion exchange member may comprise a polymeric gel. The ion exchange membrane may be a Nafion (RTM) ion exchange membrane produced by E.I du Pont de Nemours & Co., Inc and available from Sigma-Aldrich Fine Chemicals.

Advantageously, the cathode is outside the flow conduit and a separator which has ion exchange capability is present between the cathode and flow conduit. Thus, the fluid that flows through the flow conduit does not come into contact with the cathode. Such an arrangement may prevent biofouling of the cathode surface. Preferably, the cathode is in intimate contact with the separator which has ion exchange capability. Therefore, charge is transferred directly from the separator to the cathode without the need for a separate catholyte comprising charged ions for transferring charge from the separator to the cathode. Thus, the need to include a catholyte, which is typically a toxic, non-sustainable electrolyte such a hexacyanoferrate(III) solution in the fuel cell is obviated.

The cathode may comprise a conducting material and a catalyst. Preferably the conducting material is a carbon cloth. Preferably, the catalyst comprises platinum or other transition metal such as cobalt. The cathode may be an air cathode. The use of air cathodes in fuel cells is well known. In one embodiment of the invention the cathode is an air cathode that comprises a carbon cloth impregnated with a platinum-containing catalyst. Advantageously, the cathode is exposed to the air. Preferably, the cathode is exposed to free air in the atmosphere. Thus, the need to pump air or oxygen to bring oxygen into contact with the cathode is obviated. Preferably, the outer structure of the flow conduit comprises a membrane electrode assembly (MEA) which one surface of the cathode is in intimate contact with the separator and the other surface of the cathode exposed to the atmosphere. Preferably, at least 50%, more preferably at least 80% and especially at least 90% of one surface of the cathode is exposed to the atmosphere. Advantageously, the cathode is outside the flow conduit and is separated from the flow conduit by an separator, wherein one surface of the cathode is in intimate contact with the separator and the opposing surface of the cathode is exposed to atmospheric air. Suitable membrane electrode assemblies (MEAs) include MEAs consisting of separator and the commercialized Pt-carbon cloth obtained from E-TEK Division (Somerset, N.J., USA) and other cathodes comprising cloth impregnated with carbon black and platinum or cobalt powder.

Preferably, the flow conduit inclined at an angle of from 0.5 to 45° to the horizontal. Preferably, the flow conduit is inclined at an angle of at least 1°, more preferably at least 2° to the horizontal. The provision of a flow conduit at an angle inclined to the horizontal has been found to enable any gas released in the operation of the fuel cell (for example, CO₂ from microbial cell respiration or hydrogen gas produced in a BEAMR process) to rise up along the flow conduit and collect at the highest point. Advantageously, the flow conduit further comprises a gas outlet in the region of the highest point of the incline, thus allowing evolved gas to be released. Preferably gas is caused to rise up the inclined flow conduit. Preferably, gas is released from the flow conduit. Advantageously, the flow conduit is horizontal or inclined at an angle of no more than 45° to the horizontal. Preferably, the flow conduit is inclined at an angle of no more than 20°, more preferably no more than 15° and especially no more than 10° to the horizontal. The lower the angle of inclination, the less mixing of the fluid flowing through the tube in the direction of flow will be caused by gas evolved in the processes of the fuel cell. An optimum angle of inclination has been found to be approximately 5° to the horizontal. The closer the conduit is to the horizontal, the closer the direction of movement of any evolved gas will be to a line orthogonal to the direction of fluid flow. Movement of gas in an across flow direction promotes mixing of the fluid in a direction orthogonal to fluid flow without resulting in mixing in the direction of fluid flow and therefore is advantageous in an fuel cell arrangement in which plug flow liquid flow conditions are desirable. Preferably the flow conduit is inclined upwardly in the direction of fluid flow. An upward inclination in the direction of flow may also facilitate the provision of liquid near plug flow as gas bubbles rise with the flow of the fluid.

In use the biological fuel cell of the invention contains a biological catalyst for catalysing an electrochemical reaction. The biological catalyst may be an enzyme. The enzyme may be entrapped on the anode, for example, in a film such as a polytetrfluoroethylene (PTFE), an electrogenerated polypyrrol or other polymeric film. Preferably, the biological catalyst comprises a microbe. In operation, the fuel cell may comprise a mediator for transferring charge from the electrochemical reaction site to the anode. Advantageously, the fuel cell contains in use more than one biological catalyst for catalysing an electrochemical reaction. For example, the biological fuel cell may contain a plurality of different enzymes or the fuel cell may be an MFC and contain microbes of more than one trophic group. Preferably, the relative concentrations of the biological catalysts are not uniform along the length of the flow conduit. Preferably, the flow conduit is divided into a plurality of sections for accommodating different biological catalysts. The provision of different biological catalysts along the length of the flow conduit may facilitate the treatment of complex substrates. For example, the fuel cell of the invention may be used to process waste products from industrial or agricultural processes that include large molecules, such as starches and cellulose, and the cell may be arranged to include more than one biological catalyst for breaking down and processing the complex substrate in stages. Successive enzymes or trophic groups of bacteria may processes different parts of the residues of the complex substrate or process the by-products of a previous biological process. Thus, increased efficacy in processing substrates and greater efficiency in producing electricity from a substrate may be achieved by varying the distribution of biological catalysts along the length of the flow conduit. It also gives stability to the biochemical process to cope with variations of input substrate. For example, a biological fuel cell containing a plurality of different catalysts may be able to function when a range of different the organic materials are loaded into the flow conduit. The operation of the fuel cell with substrate carrying fluid passing through a flow conduit with a substantially plug flow has been found to be advantageous for use in fuel cells in which different biological catalysts are distributed along the length of the flow conduit. A fuel cell operated with a substantially plug flow with minimal mixing of the fluid in the direction of flow may enable the constitution of the substrate to be successively transformed along the length of the flow conduit by the different biological catalysts.

The bacteria in an MFC of the invention may be planctonic (freely suspended individuals). Preferably, the bacteria is in flocs, in grains, in biofilms or immobilised on the anode, for example as biofilms on the anode, or in transition between or a combination of any of those states. The bacterium may include one or more of Clostridia, E-Coli, Bacillus, Shewenella, Rhodoferax and Psudomonas. Such bacteria are particularly suitable for use in fuel cells of the invention in which the bacteria is planctonic or in flocs and grains. The bacteria may include anodophilic species. Anodophilic species attach themselves directly onto an electron acceptor surface such as an anode and transfer electrons from their electron transfer pathways to the electron acceptor. Examples of anodophilic bacteria include Geobacter species such as Geobacter sulfurreducens and Rhodoferax ferrireducens. Anodophilic bacteria have been found to directly reduce the anode by direct contact processes and are particularly suited to use in cells in which the bacteria is immobilised on the anode.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWING

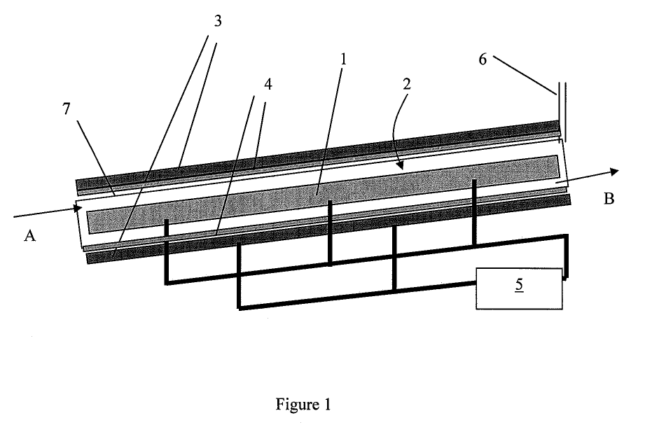

An embodiment of the present invention will now be described by way of example only with reference to FIG. 1, which shows a schematic view of a cross section in a vertical plane though part of a biological fuel cell of the invention.

### DETAILED DESCRIPTION

The biological fuel cell of FIG. 1 includes an elongate anode 1, a flow conduit 2, a cathode 3, an ion exchange membrane 4, an external circuit in which both the anode 1 and the cathode 3 are connected to a load 5 and a gas release outlet 6. The flow conduit 2 includes a wall 7. The anode 1 in the embodiment of FIG. 1 is an elongate, cylindrical, monolithic, graphite rod of circular cross section with a textured microporous surface formed by wrapping the rod in a conductive carbon textile to encourage attachment of biomass. The elongate anode 1 is surrounded by the flow conduit 2. The wall 7 is a polypropylene tube with a perforated surface around which is the ion exchange membrane 4. The ratio of the length of the flow conduit 2 to the width of the flow conduit 2 is approximately 7:1. The ion exchange membrane 4 is wrapped around the wall 7 and is a sheet of ion exchange membrane e.g. CMI-7000 Cation Membrane supplied by Membranes International, Inc of Glen Rock, N.J., USA. The cathode 3 is a standard air cathode comprising a carbon cloth impregnated with a platinum catalyst wrapped around and in intimate contact with the ion exchange membrane 4. The opposing surface of the cathode 3 to that which is in contact with the ion exchange membrane 4 is exposed to the atmosphere.

In operation, waste water (not shown) that includes organic effluent is continually fed into the lower end of the flow conduit 2 through an inlet (not shown) in the direction of arrow A. The waste water flows parallel to, and in a substantially plug flow, along the entire length of the elongate anode 1. The fluid flow leaves the flow conduit 2 via an outlet (not shown) in the direction of arrow B. Biomass (not shown) present in the waste water contains microbes that act as biological catalysts congregate on the porous surface of the anode 1 and thus are retained in the flow conduit 2. As the waste water flows along the flow conduit 2, organic material is consumed in electrochemical processes that are catalyzed by the microbes. The microbes that are at the upstream end of the flow conduit 2 are of a different trophic group to those that congregate downstream which consume the by-products of the cell respiration of the upstream microbes. Due to the essentially plug flow of waste water though the flow conduit 2 with little mixing in the flow direction, the nature of the organic matter substrate present in the water gradually changes along the length of the conduit and the microbes of different trophic groups successively process the organic substrate reducing the chemical oxygen demand of the waste water. In that manner not only is the chemical oxygen demand of the waste water reduced to an acceptable level but a larger power output is achieved than if a single trophic group of microbes were present or if the microbes were evenly distributed throughout the length of the flow conduit 2.

The flow conduit 2 is inclined at 5° to the horizontal with the fluid flowing up the incline in the direction of arrows A and B. Gas evolved in the electrochemical processes of the anode 1 rises to the top of the upper edge of the flow conduit 2 and then along the containment vessel 7 to the gas outlet 6 where it is released. As the gas rises from the anode 1 in a direction that is substantially orthogonal to the direction of flow, (i.e. at 5° to a line normal to the direction of flow) minimal mixing of the waste water in a direction of flow is produced by the rising gas.

Whilst the present invention has been described and illustrated with reference to a particular embodiment, it will be appreciated by those of ordinary skill in the art that the invention lends itself to many different variations not specifically illustrated herein. By way of example only, certain possible variations will now be described. The biological catalyst may be enzymatic and the flow conduit may be inoculated with the catalyst prior to operation. In some embodiments the anode surface is divided into a plurality of sections and each section is inoculated with a different biological catalyst. For example, in a fuel cell designed to consume cellulose the first section may be inoculated with endoglucanase enzymes or microbes that contain significant levels of such enzymes that cleave crystalline cellulose to produce large insoluble chunks of cellulose that are then cloven by exoglucanases that are present in a second section to produce soluble cellodextrins which are, in turn, consumed in a further section to produce glucose and other monosaccarides which are consumed by further enzymes or microbes in a final section of the flow conduit. The biological fuel cell of the invention may be operated as a reverse fuel cell with the load being replaced by a source of electrical energy that increases the energy available to the bacteria for their life processes and therefore drives the biochemical processes of the cell to metabolize organic matter such a complex organic compounds in industrial effluent. The cell could also be operated in a BEAMR process to produce hydrogen that rises up trough the flow conduit and is collected from the gas outlet.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1-24. (canceled)

25. An apparatus for use in a microbial fuel cell, the apparatus comprising: an elongate anode, a cathode and a flow conduit though which a fluid comprising a substrate flows in use, wherein the flow conduit is arranged so that, in use, the fluid comprising the substrate flows along the elongate anode and flows substantially parallel to at least 80% of the length of the elongate anode; and the ratio of the length of said flow conduit to the width of said flow conduit is at least 20:1.

26. The apparatus of claim 25, wherein the flow conduit is tubular.

27. The apparatus of claim 25 wherein the aspect ratio of the length of said flow conduit to the width of said flow conduit is at least 50:1.

28. The apparatus of claim 25, wherein the flow conduit is curved in a coil.

29. The apparatus of claim 25, wherein the separation of the anode and the cathode is no more than 40% of the width of the flow conduit.

30. The apparatus of claim 25, wherein the anode forms at least a part of a wall of the flow conduit.

31. The apparatus of claim 25, wherein the anode is surrounded by the flow conduit.

32. The apparatus of claim 25, wherein the cathode is elongate and is arranged lengthwise parallel to the flow conduit.

33. The apparatus of claim 25, wherein the cathode is outside the flow conduit and at least a part of a wall of the flow conduit is arranged to allow cations to pass through.

34. The apparatus of claim 25, wherein a separator, having ion exchange capability is arranged between the flow conduit and cathode.

35. The apparatus of claim 34, wherein a surface of the cathode is in intimate contact with the separator.

36. The apparatus of claim 35, wherein the cathode is an air cathode and the surface of the cathode opposed to the surface of the cathode that is in intimate contact with the separator is exposed to the atmosphere.

37. The apparatus of claim 25, wherein the flow conduit is inclined upwardly in the direction of fluid flow at an angle of from 0.5 to 45° to the horizontal.

38. The apparatus of claim 37, further comprises a gas outlet in the region of the highest point of the incline of the flow conduit.

39. The apparatus of claim 25, wherein the flow conduit is divided into a plurality of sections for accommodating different biological catalysts.

40. A microbial fuel cell including the apparatus of claim 25 and which further includes, in operation, a microbe.

41. A method of operating a microbial fuel cell comprising an elongate anode, a cathode, a flow conduit through which a fluid comprising a substrate flows and a microbe which catalyses an electrochemical reaction, wherein the ratio of the length of said flow conduit to the maximum width of said flow conduit is at least 20:1,
the method including the steps of:
a. causing the fluid to flow within the flow conduit along the length of the elongate anode; and
b. causing the fluid to flow substantially parallel to the anode for at least 80% of the length of the anode.

42. The method of claim 41, wherein the flow conduit is inclined at an angle of from 0.5 to 45° to the horizontal and the fluid is caused to flow up the incline.

43. The method of claim 41, wherein the fluid flows substantially parallel to the anode for at least 80% of the length of the anode in a substantially plug flow.

44. The method of claim 41, wherein the fluid flows substantially parallel to the anode for at least 80% of the length of the anode in at least 1% plug flow, wherein the percentage plug flow is measured by introducing a tracer at an tracer inlet and measuring the concentration of tracer at a downstream monitoring position, and the percentage plug flow being calculated according to the following formula:
P=100(1−[V(T₂−T₁)/D])
wherein:
P is the percentage plug flow;
D is the distance in meters between a the centre of the tracer inlet and the downstream monitoring position;
V is average flow velocity in meters per second of fluid in the flow conduit between the tracer inlet and the downstream monitoring position;
T₁ is the time taken in seconds for volume of tracer fluid to be introduced through the inlet; and
T₂ is the time taken in seconds for 70% of the volume of tracer fluid to pass the downstream monitoring position.
